(19) United States
(12) Patent Application Publication
(10) Pub. No.: US 2006/0255170 A1
(43) Pub. Date: Nov. 16, 2006

(54) Drinking straw

(76) Inventor: Byung Soo Kim, Daegu (KR)

Correspondence Address: LADAS & PARRY LLP, 224 SOUTH MICHIGAN AVENUE, SUITE 1600, CHICAGO, IL, 60604, US

(21) Appl. No.: 11/384,228

(22) Filed: Mar. 17, 2006

(30) Foreign Application Priority Data
Mar. 17, 2005 (KR) KR20-2005-0007189

(51) Int. Cl. A47G 21/18; B05B 1/30

(52) U.S. Cl. 239/33; 239/571; 239/570

(57) ABSTRACT

Provided is a straw for drinking a beverage, which includes a straw main body which transfers the beverage, a hollow opening and closing tube which is adherently installed inside the main body, an opening and closing control ball which opens and closes the upper hollow portion of the opening and closing tube, and a hollow support tube which is installed spaced from the opening and closing tube interposing the opening and closing control ball between the hollow support tube and the opening and closing tube, to thereby support the upper portion of the opening and closing control ball, and on the lower side of which a plurality of grooves are formed in the longitudinal direction, to thereby make the beverage flowing along the circumferential surface of the opening and closing control ball flow upwards. Therefore, the beverage which has risen up to the upper end portion of the straw is prevented from falling down again into a beverage vessel such as a can or bottle. As a result, a user can drink a beverage hygienically. Also, although a plurality of users having a respective straw drink a beverage contained in a single vessel, they are prevented from contagion of viruses by the others. As a result, a plurality of the users can drink the beverage contained in the single container hygienically.

### CROSS-REFERENCE TO RELATED PATENT APPLICATION

This application claims the benefit of Korean Utility Model Registration Application No. 20-2005-0007189, filed on Mar. 17, 2005, in the Korean Intellectual Property Office, the disclosure of which is incorporated herein in its entirety by reference.

### BACKGROUND OF THE INVENTION

1. Field of the Invention

The present invention relates to a drinking straw, and more particularly, to a drinking straw including a reflux prevention unit, to thereby enable a user to suck and drink a beverage readily and sanitarily.

2. Description of the Related Art

In general, people drink a beverage such as milk in a pack, soda in a can, juice in a bottle using a drinking straw.

A conventional cheap and simple drinking straw has a configuration of a hollow tube made of a synthetic resin.

When a user uses a conventional drinking straw in order to drink a beverage, he or she does not suck and drink all the beverage at a time but sucks and drinks a part of the beverage to then take a break and suck and drink the beverage little by little. In this case, saliva in the oral cavity can flow down into a vessel such as a drinking water bottle through the drinking straw, to thereby cause a very insanitary situation. In particular, when a few people drink together, saliva of the others may flow in the drinking water bottle, to thereby cause the bacterial contagion or pollution in the drinking water bottle.

Accordingly, the conventional drinking straw has been improved into a structure that the upper end portion of the straw is bendable. If a user keeps the straw away from his or her mouth during sucking and drinking a beverage from a container, in the case that the upper end portion of the straw is bent, a part of the beverage may overflow or spill through the upper end portion of the straw. Thus, if he or she erects the upper end portion of the straw, the beverage may flow into the container together with saliva, as described above.

Besides, various types of drinking straws are known. For example, the following U.S. patents describe various types of drinking straws.

U.S. Pat. No. 6,948,664 to. Paul Daniel Sheedy on Sep. 27, 2005 entitled “Drinking straw”

U.S. Pat. No. 6,929,135 to Hajianpour, Zoya on Aug. 16, 2005 entitled “Drinking straw”

U.S. Pat. No. D490,638 to Gray, Anna Shealy on Jun. 1, 2004 entitled “Drinking straw”

U.S. Pat. No. 6,264,114 to Chow, Robert Chung Nam on Jul. 24, 2001 entitled “Drinking straw”

U.S. Pat. No. D332,198 to Goodman, Jr., Francis M. on Jan. 5, 1993 entitled “Drinking straw”

U.S. Pat. No. 6,394,302 to Query, Jr., Henry C. on May 28, 2002 entitled “Drinking cup with straw lid”

While some of the objects and the structural arrangements of the above described devices, at first appearance, have much differences from the present invention, they differ particularly in shape and function respects. These differences, which will be described in more detail hereinafter, are essential for the effective use of the invention and which admit of the advantages that are not available with the prior devices.

### SUMMARY OF THE INVENTION

To solve the above problems of the conventional art, it is an object of the present invention to provide a drinking straw with a built-in reflux prevention unit, to thereby enable a user to suck and drink a beverage readily and sanitarily.

To accomplish the above object of the present invention, there is provided a straw for drinking a beverage, the drinking straw comprising: a straw main body which transfers the beverage; a hollow opening and closing tube which is adherently installed inside the main body; an opening and closing control ball which opens and closes the upper hollow portion of the opening and closing tube; and a hollow support tube which is installed spaced from the opening and closing tube interposing the opening and closing control ball between the hollow support tube and the opening and closing tube, to thereby support the upper portion of the opening and closing control ball, and on the lower side of which a plurality of grooves are formed in the longitudinal direction, to thereby make the beverage flowing along the circumferential surface of the opening and closing control ball flow upwards.

Preferably, an elastic member is installed between the opening and closing control ball and the support tube.

Preferably, an extension portion which maintains the distance between the support tube and the opening and closing tube is integrally protrudingly formed at the lower edge portion of the support tube.

Preferably, a corner portion is formed inside the support tube in order to smoothly install the elastic member.

Preferably, an inclined surface is formed on the upper end of the opening and closing tube.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a perspective view showing a drinking straw according to the present invention;

FIG. 2. is an exploded perspective view showing the drinking straw according to the present invention;

FIG. 3 is a cross-sectional view showing the drinking straw cut along a line A-A of FIG. 1 according to an embodiment of the present invention;

FIG. 4 is a cross-sectional view showing a drinking straw according to another embodiment of the present invention;

FIG. 5 is a cross-sectional view showing a drinking straw according to still another embodiment of the present invention;

FIG. 6 is a perspective view showing another example of a use state of the straw according to the present invention.

### DETAILED DESCRIPTION OF THE INVENTION

A drinking straw according to a preferred embodiment of the present invention will be described with reference to the accompanying drawings.

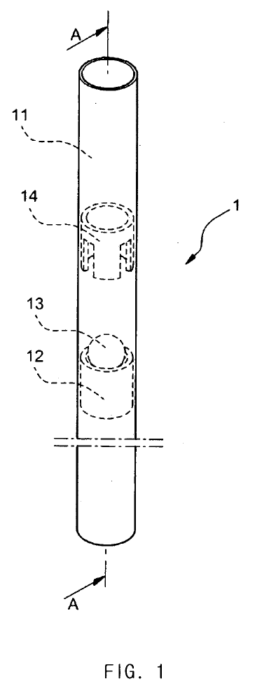

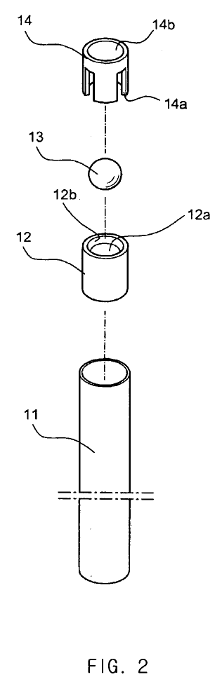

FIGS. 1 through 3 show a drinking straw according to the present invention, in which the drinking straw 1 has a structure that the beverage flowing out from the lower portion of the straw 1 to the upper portion thereof is prevented from falling down to the lower portion thereof again.

That is, the straw 1 according to the present invention includes an opening and closing tube 12, an opening and closing control ball 13, and a support tube 14 which are installed inside a straw main body 11 in turn. The opening and closing tube 12 and the support tube 14 are installed in closely contact with the inner surface of the straw main body 11.

Here, the straw main body 11 has an identical structure to a conventional structure. That is, the straw main body 11 is formed into a tubular shape made of a plastic material, to accordingly transfer the beverage located below the straw to the mouth via the inside of the straw.

Of course, it is apparent to one skilled in the art that the straw main body 11 may be formed of a metallic material including stainless steel pipes.

The opening and closing tube 12 includes a hollow portion 12a, which is adherently installed inside the straw main body 11.

An inclined surface 12b is formed on the top end portion of the hollow portion 12a in the opening and closing tube 12. Accordingly, the opening and closing control ball 13 easily seals the opening and closing tube 12.

The opening and closing control ball 13 is spherically shaped to open and close the upper hollow portion 12a of the opening and closing tube 12, which is made of a synthetic resin, or a metallic material.

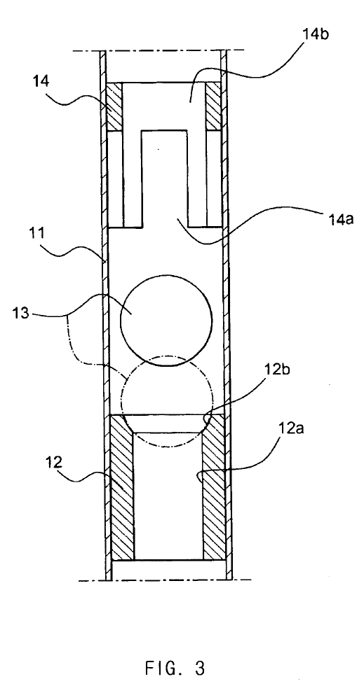

Of course, it is preferable that the opening and closing control ball 13 is made of a metallic material including stainless steel which is a heavy material in order to easily seal the opening and closing tube under the load of the opening and closing control ball 13. The incline surface 12b formed in the upper portion of the hollow portion 12 may be formed in conformity to the curvature surface of the opening and closing control ball 13 as shown in FIG. 3.

The opening and closing control ball 13 is interposed between the support tube 14 and the opening and closing tube 12. The support tube 14 is installed separately from with the opening and closing tube 12. Accordingly, the support tube 14 supports the top unit of the opening and closing control ball 13, to thereby prevent the opening and closing control ball 13 from seceding toward the upper end portion of the straw main body 11. A number of grooves 14a are formed in the longitudinal direction at the lower side of the support tube 14, to thereby make the beverage flowing along the circumferential surface of the opening and closing control ball 13 flow to the upper side of the straw 1.

The support tube 14 constitutes a hollow portion 14b as in the opening and closing tube 12. Thus, the beverage rising up along the circumferential surface of the opening and closing control ball 13 flow along the hollow portion 14b via the grooves 14a.

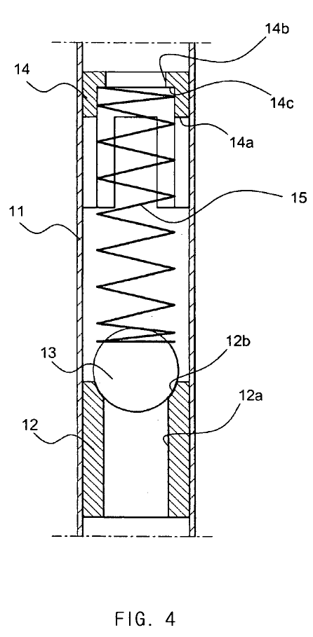

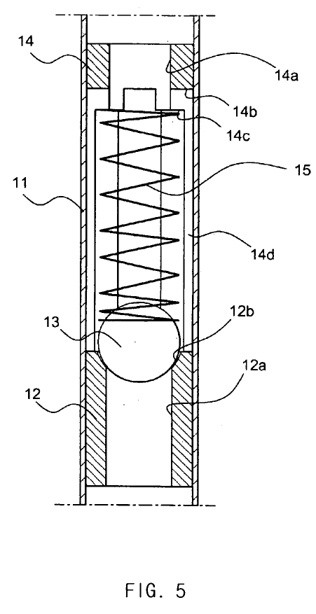

In the meantime, as shown in the FIGS. 4 and 5, the drinking straw according to the present invention includes an elastic member 15 between the opening and closing control ball 13 and the support tube 14, so that the opening and closing control ball 13 can seal the opening and closing tube 12 although the drinking straw 1 is not kept erected.

Of course, in this embodiment, a corner portion 14c is formed inside the support tube 14 in order to smoothly install the elastic member 15. Although an extension portion 14d is formed as will be described later, the corner portion 14c is adjustably positioned, to thereby make the beverage flowing along the circumferential surface of the opening and closing control ball 13 flow smoothly.

That is, as shown in FIG. 5, the present invention has a structure that the extension portion 14d which maintains the distance between the opening and closing tube 12 and the support tube 14 is integrally protrudingly formed in the lengthy direction at the lower edge portion of the support tube 14, in order to keep the distance between the opening and closing tube 12 and the support tube 14 and thus prevent the support tube 14 and the opening and closing tube 12 from excessively approaching each other during assembly.

The drinking straw 1 according to the present invention as constructed above functions as follows.

A user inserts a drinking straw 1 into a container such as a bottle containing a beverage, and then sucks the upper end portion of the straw 1 with his or her mouth. Then, the inner pressure in the straw 1 is lowered. Accordingly, the beverage rises up and the opening and closing control ball 13 gets to move like a solid line of FIG. 3 at the same time.

Then, the beverage passes by the circumferential surface of the opening and closing control ball 13 and passes through the grooves 14a of the support tube 14 to then pass through the hollow portion 14b of the support tube 14, and finally flow into the mouth of the user.

Then, if the user no more drinks the beverage by stopping the suction force, the beverage falls down and simultaneously the opening and closing control ball 13 moves as shown in a dashed circle of FIG. 3, to accordingly block the opening and closing tube 12, and prevent any reflux of the beverage.

Therefore, saliva in the mouth is prevented from falling down to the bottle together with the beverage.

In the meantime, since the straw is thrown away into a trash box after use, the consumption expenses of the straw may unnecessarily increase, in the above-described embodiment of the present invention.

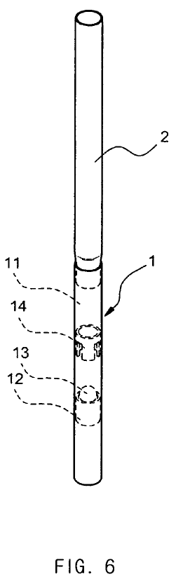

Thus, as shown in FIG. 6, if a drinking straw 1 according to the embodiment of the present invention is connected with the lower portion or the upper portion of a conventional drinking straw 2 in use, the consumption cost may be reduced.

As described above, the opening and closing tube 12, the opening and closing control ball 13, and the support tube 14 are installed inside the straw main body 11 in turn, in the drinking straw 1 according to the present invention. Thus, the beverage which has risen up to the upper end portion of the straw is prevented from falling down again into a beverage vessel such as a can or bottle. As a result, a user can drink a beverage hygienically. Also, although a plurality of users having a respective straw drink a beverage contained in a single vessel, they are prevented from contagion of viruses by the others. As a result, a plurality of the users can drink the beverage contained in the single container hygienically.

As described above, the present invention has been described with respect to particularly preferred embodiments. However, the present invention is not limited to the above embodiments, and it is possible for one who has an ordinary skill in the art to make various modifications and variations, without departing off the spirit of the present invention.

What is claimed is:

1. A straw for drinking a beverage, the drinking straw comprising:
a straw main body which transfers the beverage;
a hollow opening and closing tube which is adherently installed inside the main body;
an opening and closing control ball which opens and closes the upper hollow portion of the opening and closing tube; and
a hollow support tube which is installed spaced from the opening and closing tube interposing the opening and closing control ball between the hollow support tube and the opening and closing tube, to thereby support the upper portion of the opening and closing control ball, and on the lower side of which a plurality of grooves are formed in the longitudinal direction, to thereby make the beverage flowing along the circumferential surface of the opening and closing control ball flow upwards.

2. The drinking straw according to claim 1, wherein an elastic member is installed between the opening and closing control ball and the support tube.

3. The drinking straw according to claim 1, wherein an extension portion which maintains the distance between the support tube and the opening and closing tube is integrally protrudingly formed at the lower edge portion of the support tube.

4. The drinking straw according to claim 1, wherein a corner portion is formed inside the support tube in order to smoothly install the elastic member.

5. The drinking straw according to claim 1, wherein an inclined surface is formed on the upper end of the opening and closing tube.

6. The drinking straw according to claim 2, wherein an inclined surface is formed on the upper end of the opening and closing tube.

7. The drinking straw according to claim 3, wherein an inclined surface is formed on the upper end of the opening and closing tube.

8. The drinking straw according to claim 4 wherein an inclined surface is formed on the upper end of the opening and closing tube.
